(19) United States
(12) Patent Application Publication
(10) Pub. No.: US 2003/0116078 A1
(43) Pub. Date: Jun. 26, 2003

(54) Whistle with several chambers

(76) Inventors: Simon M. Topman, Hockley (GB); Michael C. Sharp, Hockley (GB)

Correspondence Address: Welsh & Katz, 22nd Floor, 120 South Riverside Plaza, Chicago, IL, 60606, US

(21) Appl. No.: 10/181,113

(22) PCT Filed: Jan. 14, 2001
(86) PCT No.: PCT/GB01/00120

(30) Foreign Application Priority Data
Jan. 14, 2000 (GB) 0000785.6
Jun. 26, 2000 (GB) 0015384.1

(51) Int. Cl. G10K 5/00

(52) U.S. Cl. 116/137 R

(57) ABSTRACT

A combination whistle (1) having a mouthpiece (2) leading to bulbous whistle portion (3) which is gripped by hand when blowing into the mouthpiece. Mouthpiece (2) is common to trill chamber (4) and two pea-less chambers (5 and 6), chamber (6) being located under chamber (5).

This invention relates to a whistle and is more particularly concerned with a combination whistle.

Whistles have been in existence for quite some time and it is known for a combination whistle to be produced having a pea-less chamber associated with a mouthpiece at one end of the whistle and a chamber containing a pea or the like associated with a mouth piece at the other end of the whistle. The disadvantages and advantages associated with pea or pea-less whistle chambers are quite well known, some of which are related in other patent specifications of the Applicant, and are particularly important with regard to referees sports whistles. A referee sports whistle needs to be versatile and needs to offer the referee the facility of being able to indicate the level of seriousness of an infringement or offence, in the sound produced by the whistle or to use a certain sound to indicate that a particular action needs to be taken, for example, to indicate the end of a match or half time. In this respect, it is important that the sound to be produced is sufficient and will carry a sufficient distance without a breath pressure being required from the referee which is too exacting, uncomfortable or exhausting bearing in mind the number of times the whistle must be blown during a match. Thus, to this end, combination whistles have been produced allowing the referee to choose the type of trill sound characteristic of a pea whistle, by blowing into a mouthpiece at one end of the whistle, which effectively offers the referee the facility to “talk” in such a way as to more easily indicate the level of infringement that may have occurred during play and without requiring high breath pressure. However, if a louder and more high pitched sound is required the whistle can be turned around and a second mouth piece used to convey air to a pea-less whistle chamber which lacks the characteristic trill sound and which does not give the referee the facility to “talk” indicating the level of the infringement or type of offence that may have taken place. Equally, in using the second mouthpiece, a much greater breath pressure is required to “blow” the whistle to create the sound required. Even so the combination pea/pea-less whistle does give the referee a choice and is, therefore, much more versatile than providing the referee with either a pea whistle or pea-less whistle. Once again, it is known for the “pea” in the whistle to be replaced by an alternative form of moveable element such as a cylindrical roller element.

Additionally, it is known for whistles to be produced with one or more sound chambers connected to a common mouthpiece in a pea-less whistle. Thus, although it is believed combination pea and pea-less whistles provide the referee with a more versatile whistle it is believed that such whistles tend to be disadvantageous in that a different mouthpiece has to be selected in order to obtain the trill sound characteristic of a pea whistle or the higher loud pitched sound characteristic of a pea-less whistle and, of course, there exists the possibility that the referee may inadvertently blow into the wrong mouthpiece and not be able to produce the correct sound required. Still further, the type of sound or range of sound offered by such combination whistles may not be capable of producing all the sounds or range of sounds that may be desired. Further disadvantages may exist with such combination whistles that may be related to ease of use, bulk, or method of manufacture.

It is an object of the present invention to at least alleviate one or more of the aforementioned, or other, disadvantages associated with combination whistles or whistles including more than one sound element or sound chamber.

According to the present invention there is provided a whistle having a pea-less chamber and a chamber including a moveable element associated therewith, such as a pea or rotatable member, said chambers having a common mouthpiece or being positioned so as to be able to be blown into substantially simultaneously by a user.

Usually, the pea or rotatable member will be positioned inside the associated chamber and, in any event, will usually be able to repeatedly partially block and open a vent or opening of the associated chamber which will usually have a splitter edge which will, again usually, be of a curved shape. However, the shape of the splitter edge may be varied to suit and may be straight, rectangular, square, undulatory or mouth or top-lip shaped.

The chamber having a moveable element associated therewith will usually be a trill chamber (i.e. a chamber which will produce a trill sound when air is blown into it) and the whistle may be provided with one or more pea-less chambers.

The term “pea-less” chamber is meant to indicate that there is no pea (or like element) provided in the chamber or indeed any other moveable or rotatable element being associated therewith e.g. a chamber which is not a trill chamber.

In one embodiment of the present invention, the whistle is provided with a trill chamber to one side of the mouthpiece and at least one pea-less chamber to the other side of the mouthpiece. In such an arrangement, two pea-less chambers may be provided one above the other to one side of the trill chamber.

In an alternative embodiment, the whistle includes one trill chamber located in between two pea-less chambers, said trill chamber, preferably, being located centrally of the mouthpiece with a pea-less chamber on either side of the trill chamber, preferably, arranged symmetrically thereof.

The width of the trill chamber is, preferably, about twice the width of the, or one of the, pea-less chambers.

Where two pea-less chambers are provided in the whistle, said chambers, preferably, have discorded frequencies and/or one of the pea-less chambers may be arranged to exhaust upwardly of the whistle with the other being arranged to exhaust downwardly of the whistle (more preferably where two pea-less chambers are provided to one side of the mouthpiece with a trill chamber being provided to the other side of the mouthpiece).

Where the whistle is provided with a moveable element in the form of a rotatable member, rather than a pea, said member may be a roller or sleeve (preferably mounted on a central web inside the chamber) and said moveable element may be of plastics. The moveable element could be of any suitable form such as a flap (e.g. hinged flap) or membrane or a curled member which uncurls under air pressure and curls up on release of air pressure.

Advantageously, embodiments of the whistle will be able to produce a loud versatile multi-frequency sound. Preferably, where the whistle includes one trill chamber in between two pea-less chambers, all chambers will vent upwardly of the whistle.

The sound characteristics of the whistle may be selectively adaptable, for example, by arranging for the size (for example length) of one or more of the chambers to be adjustable or differently pre-set. Preferably, the length of at least one of the chambers may be varied by means of an adjustable plunger preferably axially adjustable in the chamber, for example, on rotation of the plunger relative to the chamber.

Many advantageous features of the present invention will be evident from the following description and drawings.

Embodiments of a whistle in accordance with the present invention, will now be described, by way of example only, with reference to the FIGURES of the accompanying drawings drawn to scale in which:

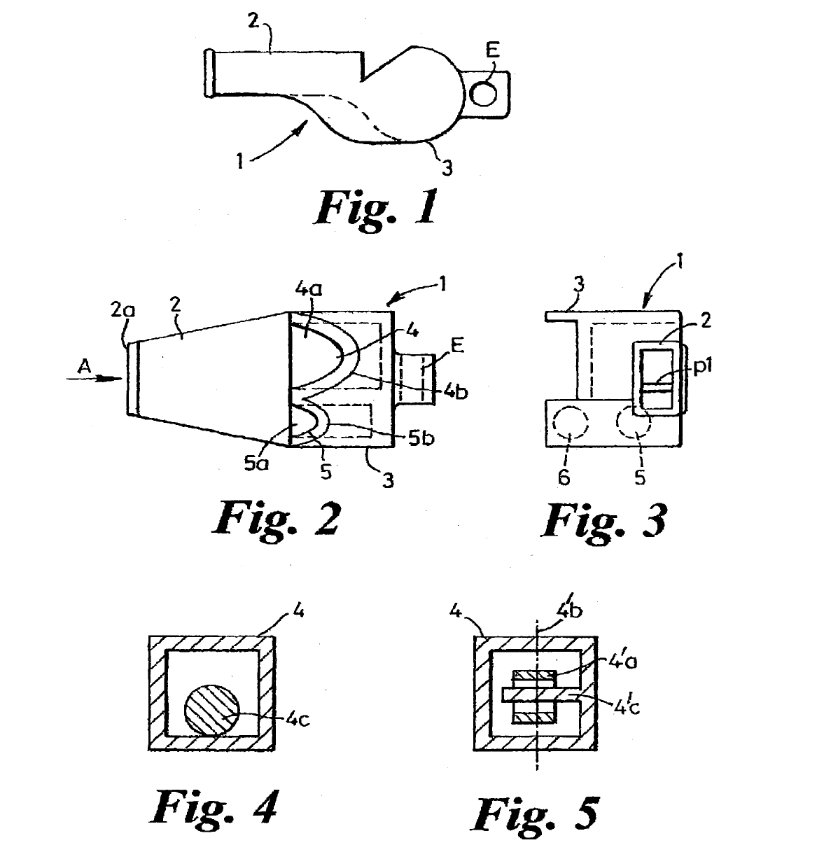

FIG. 1 shows a side view of the whistle;

FIG. 2 shows a plan view of the whistle shown in FIG. 1;

FIG. 3 shows a view of the whistle looking in the direction of Arrow A of FIG. 2;

FIGS. 4 and 5 show detail cross sections through two alternative sound chamber elements of the whistle;

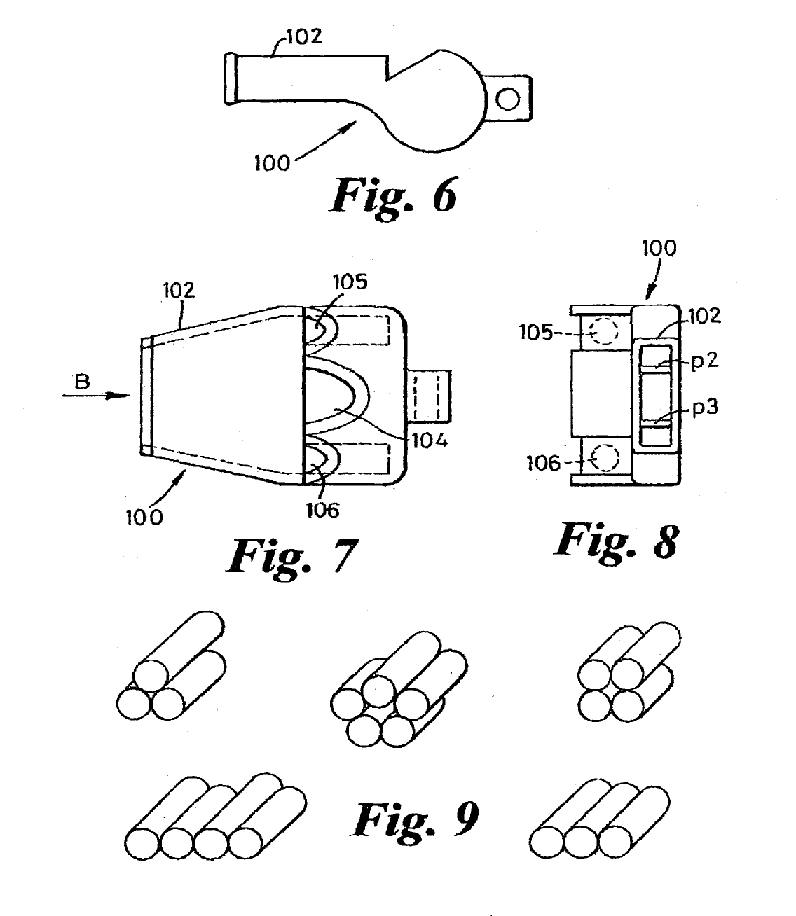

FIG. 6 shows a side view of a second embodiment of the whistle which is similar to FIG. 1;

FIG. 7 shows a plan view of the whistle of FIG. 6;

FIG. 8 shows an end view of the whistle of FIG. 6 looking in the direction of arrow B of FIG. 6;

FIG. 9 shows schematically possible sound chamber arrangements for the whistle;

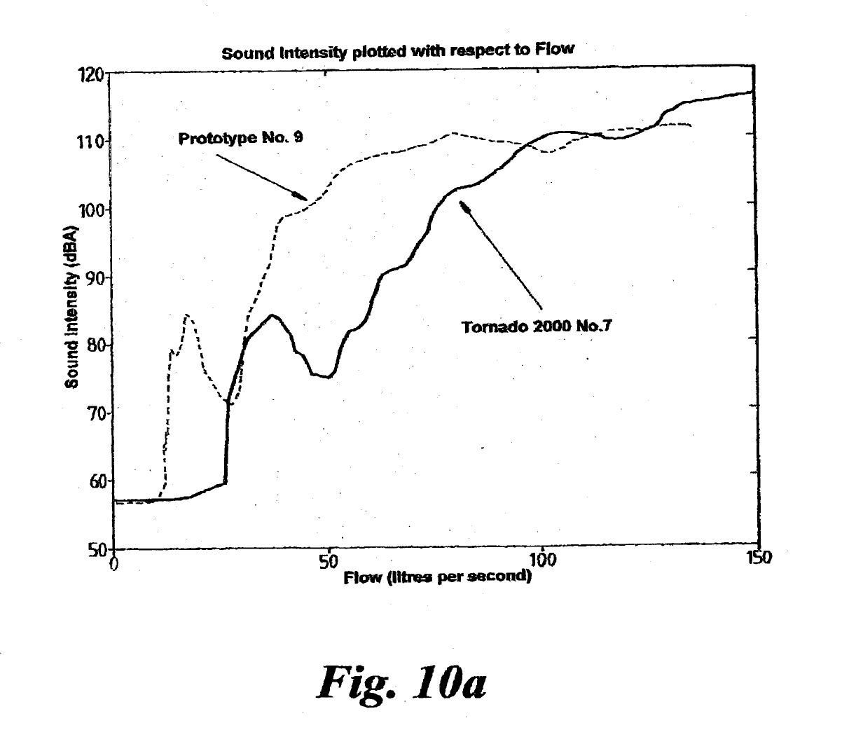

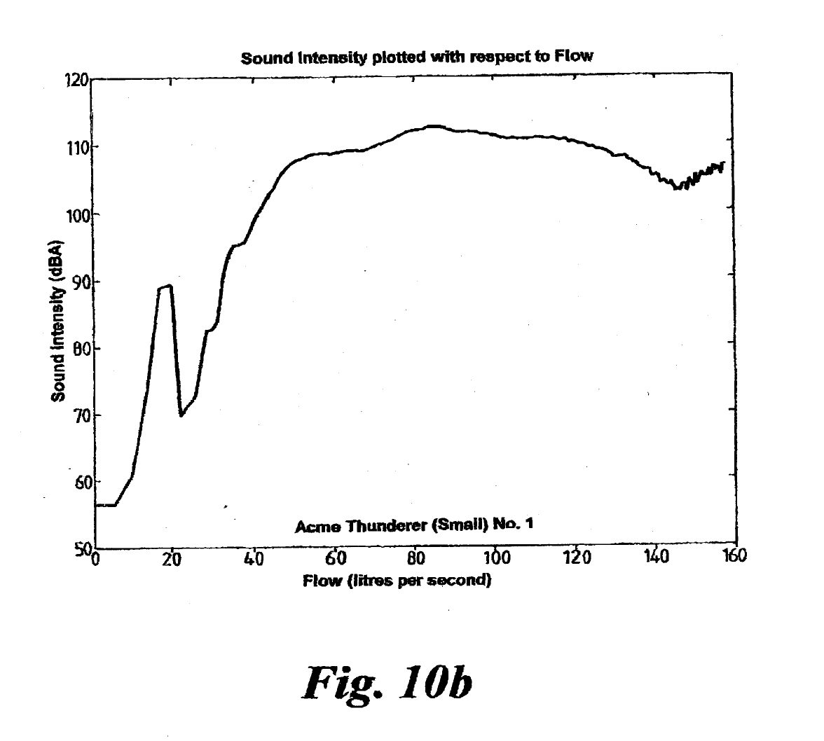

FIG. 10a shows graphs of sound intensity plotted against air flow rate for a typical ‘pealess’ whistle such as the Tornado 2000 whistle of the applicant and for a combination whistle in accordance with one embodiment of the present invention (in dashed lines), and

FIG. 10b shows a graph of sound intensity plotted against air flow rate for a typical ‘pea’ whistle such as the Acme Thunder of the Applicant.

Referring to FIGS. 1 to 5 of the accompanying drawings, a combination whistle 1 includes a mouthpiece 2 leading to a generally bulbous whistle portion 3 which is usually gripped by hand when blowing into the mouthpiece in a generally know manner. An eye E is provided for a lanyard (not shown).

Mouthpiece 2 is tapered towards the air inlet end 2a (more preferably shown in FIG. 2) and the mouthpiece 2 is common to trill chamber 4 and two pea-less chambers 5 and 6. A partition wall p1 (see FIG. 3) guides air blown in the inlet 2a to the respective sound chambers 4, 5, 6. Trill chamber 4 has an upwardly facing sound window or vent 4a defined in part by curved splitter edge 4b and may be of the generally square cross section as shown in FIG. 4 which includes a pea or ball (usually of cork) 4c that can reverberate around the chamber 4 when air is blown through the mouthpiece 2 into the trill chamber 4 through the inlet end 2a. Reverberation of the ball 4a on the inner walls of the trill chamber 4 and across the vent v brings about the characteristic trill sound in a generally know manner. As an alternative to providing the cork ball 4a in trill chamber 4, FIG. 5 shows that a moveable element may be provided in the form of a generally cylindrical sleeve or roller 4′a (usually of plastics) mounted to rotate about its own axis 4′b and mounted on integral web 4′c which extends in the longitudinal direction of the whistle 1. Thus, the roller 4′a extends transversely of the trill chamber 4.

In the arrangement as shown in FIGS. 1 to 3, whistle 1 is provided with one relatively large trill chamber 4 on the left hand side of the mouthpiece 2 and two (upper and lower) pea-less whistle chambers 5 and 6 which are arranged to vent upwardly and downwardly respectively. Pea-less whistle chamber 5 has a vent 5a partly defined by curved splitter edge 5b in a way which should be evident from the FIG. 2 of the drawings. Pea-less chamber 6 is provided with a similar vent and splitter edge (not shown for ease of illustration) which vent downwardly.

Although whistle 1 is shown having a mouthpiece 2 common to trill chamber 4 and two pea-less chambers 5 and 6, in alternative arrangement, only one trill chamber and one pea-less chamber need be provided. Thus, pea-less chamber 6 could be omitted from the design completely.

It is to be noted that the width of the trill chamber 4 is about twice the width of each pea-less chamber 5, 6 and it is believed that the overall ratio of dimensions of the trill chamber 4 to the pea-less chambers 5, 6 is particularly advantageous in producing a unique characteristic sound for the whistle.

Two pea-less whistle chambers 5 and 6 are, preferably, provided and these chambers are arranged to emit discorded frequencies with one exhausting through a vent at the top of the whistle and one through a vent at the bottom of the whistle.

It is not essential that the pea-less chamber or chambers be provided to one side of the mouthpiece 2 and indeed FIGS. 6 to 8 show an alternative embodiment of the whistle 100 in which a trill chamber 104 is arranged in between two pea-less chambers 105, 106.

Referring to FIGS. 6 to 8 of the drawings, whistle 100 has a tapered mouthpiece 102 common to trill chamber 104 and pea-less chambers 105, 106. Partition walls p2, p3 guide air blown into mouthpiece 102 to respective sound chambers 104, 105, and 106. The arrangement of pea-less chambers 105, 106 is symmetrical about the longitudinal axis of the whistle 100 and once again trill chamber 104 may include a pea or ball and be of the same general type that is shown in FIG. 4 of the drawings or alternatively a roller can be provided of the same general form as shown in FIG. 5 of the drawings.

FIG. 9 shows examples of five possible chamber configurations for the combination whistle in accordance with the present invention. Any of the chambers may or may not include a moveable element to suit. Thus, the chambers need not be located substantially in the same plane, one or more chambers may be displaced out of the plane of the remaining, or some of the remaining, chambers. Additionally, one or more chambers may be located in the cusp of adjoining chambers.

In practice, whistle 1 or 100 proved to be a loud versatile multi-frequency sound whistle having the benefits of a pea or roller type whistle combined with the benefits of a pea-less whistle thus offering a referee a greater choice of sound commands.

Quite apart from these advantages it was found that the sound characteristics of whistle 1 or whistle 100 were quite unique and in fact quite different to, and a radical departure from, the sounds produced by either a pea-less or pea/roller type whistle. Such a whistle would be particularly important e.g. if used by a referee where a nearby match was in progress with the other referee using a known type of combination whistle; this would help to avoid confusion of the players in one match responding to commands of the referee of the other match.

FIG. 10a clearly illustrates the advantages that may be gained using a combination whistle in accordance with the present invention. The dashed line labelled ‘prototype No. 9’ shows the variation of sound intensity generated by a combination whistle, made generally in accordance with FIGS. 1 to 3 of the accompanying drawings, with respect to the air flow (in liters/second) being blown through the whistle. In contrast there is shown a graph of sound intensity vs. air flow for a typical ‘pealess’ whistle of the Applicant labelled Tornado 2000 No.7 and for a typical ‘pea’ whistle of the Applicant labelled Acme Thunderer (small) No.1 (see FIG. 10b).

The unique feature of the combination whistle in accordance with the present invention is a function of the two distinct chamber types (i.e. ‘pealess’ and ‘pea’ chambers) operating together to produce unique sound characteristics. The traditional design of ‘pea’ chamber provides an easy to blow and, therefore, very efficient part of the combination whistle. Moreover, the ‘pea’ chamber of the combination whistle produces a good audible and effective sound of 85 dBA at a flow rate of only 18.5 liters/second; in comparison the typical ‘pealess’ or Tornado 2000 whistle cannot produce a sound of 85 dBa until a flow rate of 40 dBA is achieved. FIG. 10a demonstrates how the second level of the combination whistle and a ‘pealess’ whistle develop, subject to controlled pressure. A good sound level of 70 dBA to 84 dBA is reached by prototype No.9 at flow rates of only 12 to 13 liters/second. In contrast a flow rate of 50 to 54 liters/second is required to generate a similar performance from the ‘pealess’ whistle Tornado 2000 No.7. Thus, ease of blowing of the Applicant combination whistle is easily demonstrated and is comparable to that of a ‘pea’ whistle (see FIG. 10b). Usually, ‘pea’ whistle cannot produce such loud performance as ‘pealess’ whistles but offer a compromise sacrificing ultimate or maximum power for ease of blowing as illustrated by FIG. 10b. The ‘pealess’ whistle sound characteristic illustrated in FIG. 10b shows, as with prototype No.9, a good effective sound of 70 to 84 dBA at a flow rate of 12 to 13 liters/second. However, at maximum flow rates, the ‘pea’ whistle is not able to sustain the high rising sound levels of the ‘pealess’ whistle or of the combination whistle. At a flow rate of 120 liters/second, the whistle sound intensity starts to markedly decline below 110 dBA whereas the ‘pealess’ whistle and the combination whistle have sound intensities rising to well above this level. The ‘pealess’ whistle has a peak of performance which is only 80 liters/second.

‘Pealess’ whistles are louder than ‘pea’ whistles but ‘pea’ whistles are easier to blow. Thus, a combination of a ‘pea’ chamber and a ‘pealess’ chamber blown simultaneously seemingly provides the advantages of both types of whistles. Prototype No. 9 provides easy blowing of the whistle but at 92 to 96 liters/second and above the performance (or sound intensity) of the combination whistle is comparable to that of the ‘pealess’ whistle Tornado 2000 No.7 because the ‘pealess’ chamber of the combination whistle has started to activate and is now working in combination with the ‘pea’ chamber to produce a high power sound.

Thus, in blowing the combination prototype No.9 whistle the ‘pea’ chamber activates first to provide an easy blowing element to the whistles and the ‘pealess’ chamber activates a while later at a higher flow rate producing the higher power sound element.

It may be advantageous that the ‘pealess’ chamber does not start to activate until a particular air flow pressure since the sound of the combination whistle up until that point will be the traditional sound of a ‘pea’ whistle for use e.g. in refereeing a netball match. However, when the whistle is blown at a greater airflow rate than about 92 liters/second a very unique sound indeed is produced being a combination of the sounds produced from each chamber (i.e. a ‘pea’ and ‘pealess’ chamber sounding simutaneously). Such a sound would be very useful to indicate a serious infringement in e.g. a football game. No typical ‘pea’ whistle can reach the ultimate or maximum performance by a typical ‘pealess’ whistle. However, combining a ‘pealess’ whistle chamber with a ‘pea’ whistle chamber that can be sounded simultaneously provides the ease of blowing a ‘pea’ whistle with the power of a ‘pealess’ whistle.

It is believed that the unique sound produced by whistles in accordance with the present invention is itself advantageous and inventive at least when utilised in a referee or sports or arbitrating/control scenario such as a starting signal.

Overall, therefore it is believed that significant advantages are provided by whistle 1 or whistle 100 or any similar type of whistle and, whilst the various dimensions of the trill chamber and pea-less chamber/s are not critical to providing an improved or more unique whistle it is believed that the particular dimensions derivable from the FIGURES of the drawings are of particular advantage in providing good balanced sound quality.

It is to be appreciated that the present invention offers many improvements, at least some of which might be patentable individually or in combination. Any individual feature as aforementioned or as shown or implicit herein or combinations thereof or functions or methods appertaining thereto, may be patentably inventive and any specific term as used herein should not be construed as unnecessarily or unduly limiting; the scope of such a term should extend to, or may be replaced or supplemented by, any equivalent or generic expression. The single may include the plural and vice versa. Additionally, any range mentioned herein of any variable or parameter shall be taken to include a disclosure of any derivable sub range within that range or of any particular value of the variable or parameter arranged within, or at an end of, the range or sub range.

Still further according to the present invention there is provided a whistle having a pea-less chamber and a chamber with a moveable element associated therewith, the arrangement being such that the chambers can be sounded substantially simultaneously by the user.

Further according to the present invention there is provided a sound produced or substantially producible by a whistle having at least one pea-less chamber and at least one chamber including a moveable element associated therewith, said sound being produced or substantially producible by blowing into said chambers simultaneously.

Thus, it is believed such a sound is itself inventive however produced (whether originating or being copied e.g. electronically).

Still further according to the present invention there is provided a sound characteristic substantially in accordance with the prototype No. 9 graph of FIG. 10a of the accompanying drawings of this patent specification or a whistle or sound generation means adapted or arranged to produce or mimic substantially said sound characteristic.

Still further according to the present invention there is provided a sound characteristic which is more like the prototype No.9 sound characteristic of FIG. 10a of the accompanying drawings than either the Tornado 2000 No.7 sound characteristic or the Acme Thunderer (small) No.1 of FIG. 10b sound characteristic or a whistle or sound generation means adapted or arranged to produce or mimic said first mentioned sound characteristic.

Further according to the present invention there is provided a whistle adapted to produce an effective sound of about 70 to 84 dBA at a flow rate of about 12 to 13 liters/second with a sound of 110 dBA or at a flow rate of about 120 liters/second or above.

Further according to the present invention there is provided a method of refereeing including blowing into a whistle as claimed in any one of the preceding statements of invention to the whistle or including utilising a sound, or sound capable of being, produced by such a whistle or sound substantially similar thereto or to the sound characteristic of the combination whistle substantially as shown in FIG. 10a.

The Applicant has made further modifications or improvements to the combination whistle in accordance with the present invention.

Accordingly, further embodiments of a whistle in accordance with the present invention, will now described, by way of example only, with reference to further much simplified schematic FIGURES of the accompanying drawings in which:

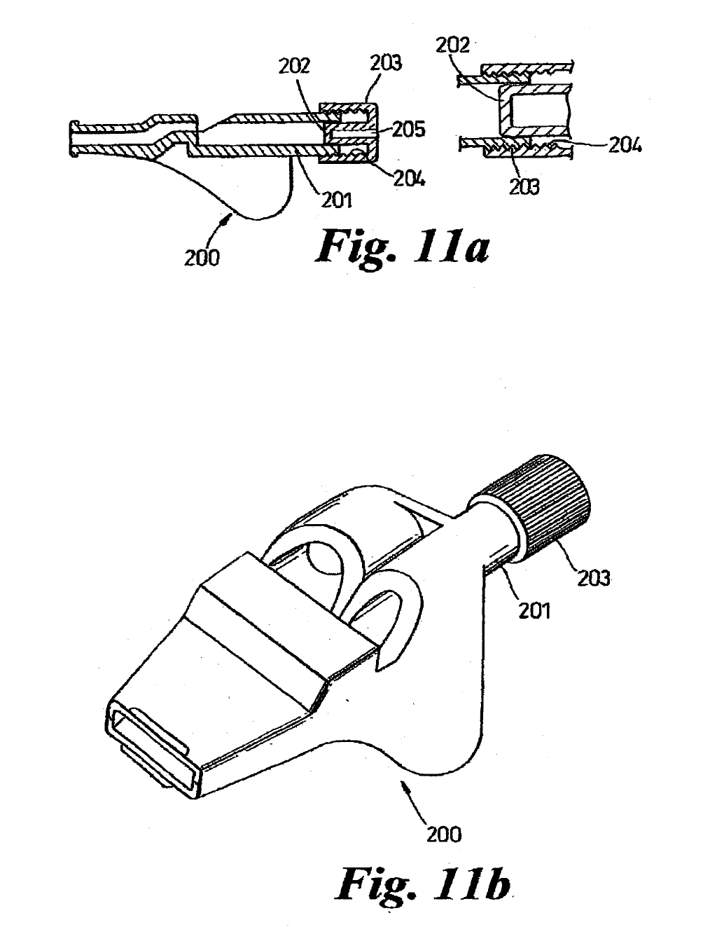

FIGS. 11a and 11b show longitudinal section and perspective views of a third embodiment of a whistle in accordance with the present invention;

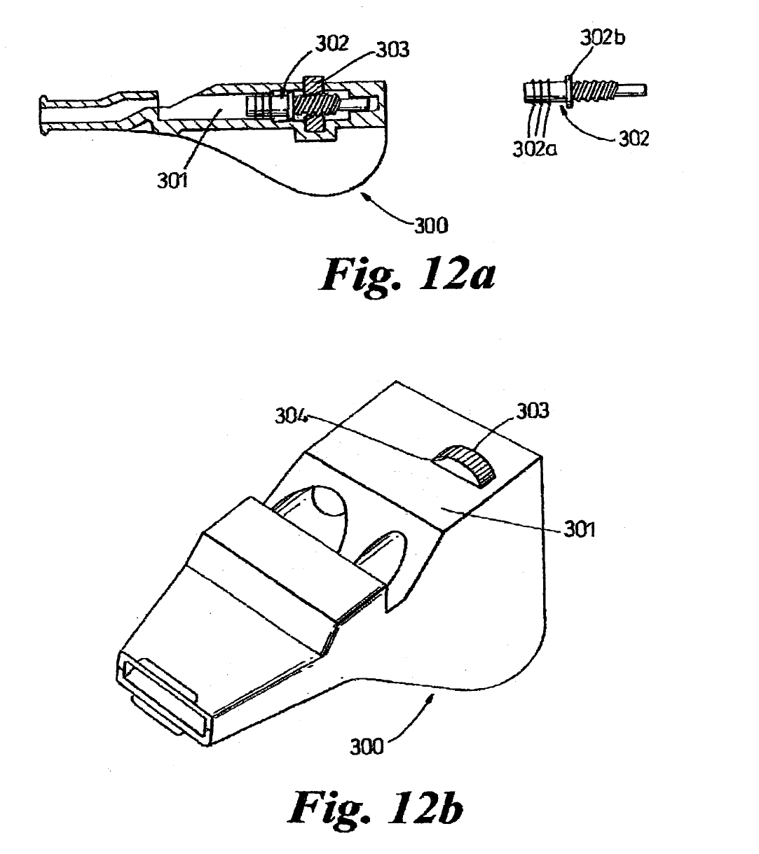

FIGS. 12a and 12b show longitudinal section and perspective views of a fourth embodiment of a whistle in accordance with the present invention, and

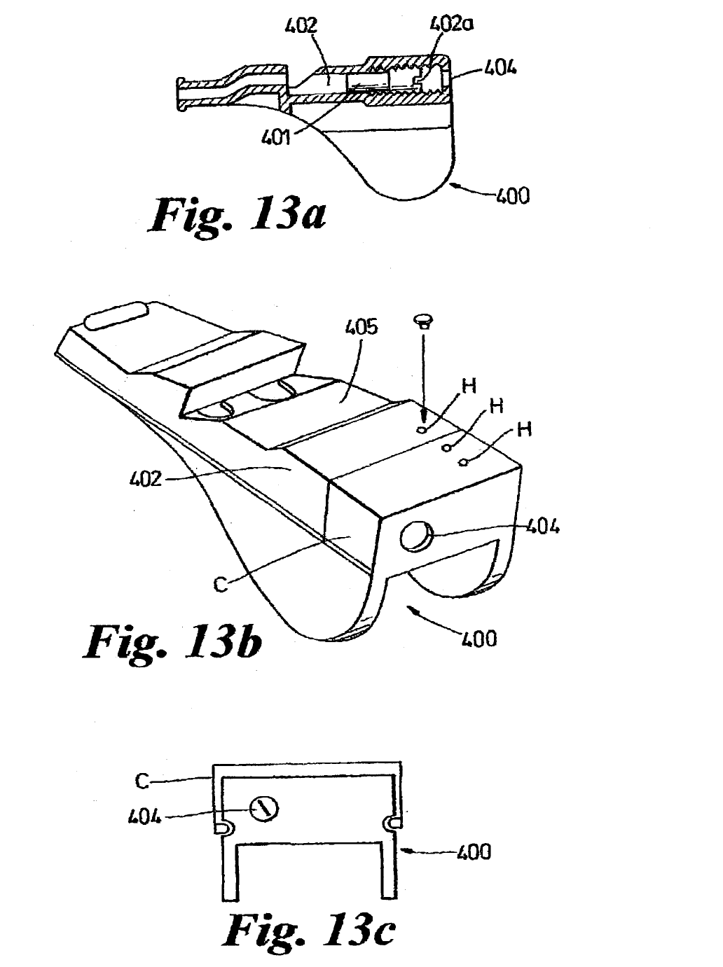

FIGS. 13a, 13b and 13c show a longitudinal section view, perspective view and a rear view of a fifth embodiment of a whistle in accordance with the present invention.

Whilst the Applicant believes the combination whistle as described, for example, in relation to FIGS. 1 to 9 of the accompanying drawings are advantageous in combining the characteristics of both a pea whistle and pea-less whistle, such a whistle is nevertheless, limited to a particular sound characteristic producing a particular sound intensity at particular flow rate (for example the graph of prototype No. 9 in FIG. 10a of the accompanying drawings). It is possible that the user of the whistle might wish to selectively vary such a sound characteristic.

Accordingly, FIGS. 11a to 13c show different ways in which this sound characteristic may be varied. The sound characteristic may be selectively varied generally by altering the size (for example length) of one or more of the chambers of the combination whistle. Alteration of the length of chamber will alter the sound volume and frequency. Importantly, variation of the sound characteristics of the whistle means the pressure or airflow required to blow or sound the whistle will vary accordingly. Thus, by reducing e.g. the size of a particular chamber, that chamber can be activated at a lower air flow rate that can be set to suit by the user. The user may prefer the whistle to be set to sound at a lower air flow rate (by altering the size of one or more of the ‘pea’ or ‘pealess’ chambers) and prefer the whistle to be easier to blow. Effectively, this facility allows a ‘designer’ whistle to be provide with a choice of level of efficiency selectable and adjustable by the user.

Referring to FIGS. 11a and 11b of the drawings, a whistle 200 (corresponding generally to whistle 1 in FIG. 1 of the accompanying drawings) has an extended pea-less chamber 201 with a plunger 202 being extendable and retractable within the chamber 201 along the length thereof in order to vary the sound volume and frequency characteristics of the whistle in a manner which should be self-explanatory.

The adjustable plunger 202 has an external diameter matching the internal diameter of the chamber 201 and is an internal central, axial projection of cap 203 fitted on to the open end of chamber 201. The cap 203 enables the plunger 202 to be held tightly in an airtight manner in the same sound chamber 201. The internal circumferential edge 204 of the cap 203 may be provided with a screw-thread matching an external screw-thread on the chamber 201 allowing the plunger 202 to be advanced and retracted in the chamber on appropriate rotation of the cap. The cap 203 may be provided with knurling or external ribbing to allow ease of rotation by hand and/or the cap may be provided with a screw-slot 205 (for example as shown in FIG. 11a running along the length of the plunger 202).

Instead of the cap 203 and chamber 201 being provided with complementary screw-threads chamber, for example, the cap need not necessarily be rotatable relative to the chamber, it may merely be reciprocable and/or engagement could be a force or friction fit. The cap may be made of any suitable material such as rubber and/or plastics. A detail of the engagement of the cap 203 with the chamber 201 is shown in FIG. 11a at the right of the sectional view through the whistle 200. Any suitable engagement may be provided allowing the adjustability of the plunger 202 in the chamber 201.

FIGS. 12a and 12b show views of a combination whistle 300; in this arrangement the pea-less chamber 301 has not been extended rearwardly on the whistle but has been modified to incorporate an externally threaded plunger 302 (shown separately to the right of sectional drawing in FIG. 12a). An adjustment wheel 303 projects through an opening 304 in the upper surface of the whistle chamber 301 and the wheel 303 is in threaded arrangement with the plunger 302 in a manner which should be self-evident from the drawings. The plunger 302 is provided with three annular flanges 302a in order to provide an airtight seal of the plunger in the chamber 301. A fourth flange 302b acts as a stop limiting the axial movement of the plunger 302 in the chamber 301. On rotation of the wheel 303 in the opening 304 transverse of the chamber 301 the threaded engagement of the wheel 303 with the plunger 302 enables axial advancement of the plunger 302 in the chamber 301 or retraction thereof in order to shorten or lengthen the chamber to vary the sound volume and frequency obtainable by blowing into the whistle, in a manner which should be generally self-explanatory.

FIGS. 13a to 13c show views of a whistle 400 depicting further ways of varying the sound characteristic of the whistle. FIG. 13a shows a longitudinal section through the whistle 400 and FIG. 13b shows a rearward perspective view of the whistle. A plunger 401 is threadably engaged with a pea-less sound chamber 402 and has an axial slot 402a that can be accessed using a screwdriver insertable through opening 404 at the rear of the chamber which should be self-evident from the drawing. Rotation of the plunger 401 in the chamber 402 axially advances the plunger to adjust the length of the chamber and thereby the sound volume and frequency obtained with the whistle.

Also in the particular embodiment shown in FIGS. 13a to 13c an arrangement is provided for varying the characteristics of the pea-chamber 405. The chamber 405 may have one or more holes H that could be closed off by a respective flanged plug or by a (preferably ‘clip’ or ‘snap-on’) cover C which may be slideable between various adjustment positions longitudinally of the whistle 400 (see in particular FIG. 13c).

Moreover, any suitable method may be provided for adjusting the size of the sound chamber. A further possibility (not shown in the drawings) is to provide a piston in one of the chambers, attached to a lever, with the lever protruding from the concealed underside of the whistle and located in a slot. Actuation of the lever back and forth may vary the position of the internal piston in the whistle chamber to vary the length of chamber.

A whistle may be provided comprising at least two pea-less chambers that could be adjusted independently and/or in unison.

It is possible that such adjustment facilities for varying the size of a chamber in a whistle may be provided on any type of whistle not necessarily a combination whistle.

Thus, any one of the aforedescribed chamber adjustment methods may be provided on a whistle only including one chamber albeit pea or pea-less.

Additionally, the Applicant believes it is important that in the arrangements discussed the sound characteristic adjustment means is not loosely fitted on the whistle for several reasons. Clearly, any rattling of the adjustment would detract from the natural sound of the whistle. It is envisaged that an o-ring seal or grommet or the like may be provided around the plunger (where provided) to sent the plunger comfortably and tightly in the associated chamber. Where the plunger is rotated (e.g. by an adjustment wheel or the like as in FIGS. 12a and 12b) the o-ring seal, grommet or the like would offer a spring resistive force to rotation allowing a more delicate or accurate control setting to be achieved (i.e. a more finely balanced tuning of the sound characteristic) with the plunger being automatically retained more readily and firmly in the adjusted position.

It is possible that a whistle may be produced in accordance with one embodiment of the present invention having a plurality of ‘pealess’ chambers arranged to be activated at different airflow rates which may or may not be adjustable. In this way the sound characteristic produced by the whistle may vary substantially each time a particular ‘pealess’ chamber is activated. Alternatively, or additionally, a plurality of ‘pea’ chambers may be provided set or adjustable to be activated at different air flow rates providing a sequential or staggered ease of blowing of said chambers.

1. A whistle (1) having a pea-less chamber (5,6) and a chamber (4) including a moveable element (4c) associated therewith, such as a pea or rotatable member, said chambers (4, 5, 6) having a common mouthpiece (2) or being positioned so as to be able to be blown into substantially simultaneously by a user.

2. A whistle (1) as claimed in claim 1 in which the moveable element (4c) is positioned inside the associated chamber (4).

3. A whistle (1) as claimed in claim 1 or claim 2 in which the moveable element (4c) is able to repeatedly partially block and open a vent (v) or opening of the associated chamber (4).

4. A whistle (1) as claimed in claim 3 in which the vent/opening (v) has a splitter edge (5b) of a curved, straight, rectangular or square shape or which is undulatory, mouth or top-lip shaped.

5. A whistle (1) as claimed in any one of the preceding claims in which the chamber having a moveable element (4c) associated therewith is a trill chamber.

6. A whistle (1) as claimed in any one of the preceding claims provided with a plurality of pea-less chambers (5,6).

7. A whistle (1) as claimed in claim 5 or claim 6 when dependent therefrom in which the trill chamber is to one side of the mouthpiece (2) and at least one pea-less chamber is provided to the other side of the mouthpiece (2).

8. A whistle (1) as claimed in claim 7 in which two pea-less chambers (5,6) are provided one above the other to one side of the trill chamber (4).

9. A whistle (1) as claimed in claim 6 including one trill chamber (4) located in between two pea-less chambers (5,6).

10. A whistle (1) as claimed in claim 9 in which all the chambers (4, 5, 6) will vent upwardly of the whistle (1).

11. A whistle (1) as claimed in claim 9 or claim 10 in which said trill chamber (4) is located centrally of the mouthpiece (2) with a pea-less chamber (5,6) on each side of the trill chamber (4).

12. A whistle (1) as claimed in claim 11 in which the pea-less chambers (5,6) are arranged symmetrically of the trill chamber (4).

13. A whistle (1) as claimed in claim 5 or any claim dependent therefrom in which the width of the trill chamber (4) is about twice the width of the pea-less chamber (5,6), or of one of the pea-less chambers (5,6).

14. A whistle (1) as claimed in claim 6 or any claim dependent therefrom having two pea-less chambers provided in the whistle (1), said chambers (5,6) having discorded frequencies and/or one of the pea-less chambers (5,6) being arranged to exhaust upwardly of the whistle (1) with the other being arranged to exhaust downwardly of the whistle (1).

15. A whistle (1) as claimed in any one of the preceding claims provided with a moveable element (4c) in the form of a rotatable member (4′a), rather than a pea, said member (4′a) being a roller or sleeve, or in which said moveable element (4c) comprises a flap or a membrane, which membrane may be curled.

16. A whistle (1) as claimed in claim 15 in which the roller or sleeve (4′a) is on a central web (4′c) inside the associated chamber (4).

17. A whistle (1) as claimed in any one of the preceding claims in which the moveable element (4c) is of plastics.

18. A whistle (1) as claimed in any one of the preceding claims able to produce a loud versatile multi-frequency sound.

19. A whistle (200) as claimed in any one of the preceding claims in which the sound characteristic is adjustable, variable or differently presettable.

20. A whistle (200) as claimed in claim 19 in which the size of at least one of the chambers (201) is adjustable.

21. A whistle as claimed in claim 20 in which the length of said adjustable sound chamber (201) may be varied by an (axially) advanceable and retractable plunger (202).

22. A whistle (300) as claimed in claim 21 in which there is a rotational or screw thread adjustment (303) to advance or retract the plunger (302) in the chamber (301).

23. A whistle (400) as claimed in claim 19 in which one or more holes (H) is/are provided in said one chamber (401), which hole or holes (H) can be plugged or covered by a (slidable) cover (C).

24. A whistle (1) substantially as herein described with reference to FIGS. 1 to 3 of the accompanying drawings or when modified substantially in accordance with FIG. 4 or FIG. 5 of the accompanying drawings.

25. A whistle (1) substantially as herein described with reference to FIGS. 6 to 8 of the accompanying drawings.

26. A whistle (1) or sound generator having a sound characteristic, or a sound characteristic, substantially as shown as that of prototype No.9 in FIG. 10a of the accompanying drawings or which is more like that of prototype No.9 than that of Tornado 2000 No.7, or of Acme Thunderer (small) No.7.

27. A whistle (1) substantially as herein described with reference to FIGS. 11a and 11b, or 12a and 12b, or 13a, 13b and 13c of the accompanying drawings.

28. A whistle (1) having a pea-less chamber (5,6) and a chamber (4) with a moveable element (4c) associated therewith, the arrangement being such that the chambers (4, 5, 6) can be sounded substantially simultaneously by the user.

29. A sound produced or substantially producible by a whistle (1) as claimed in any one of the preceding claims or substantially similar to said sound.

30. A sound produced or substantially producible by a whistle (1) having at least one pea-less chamber (5,6) and at least one chamber (4) including a moveable element (4c) associated therewith, said sound being produced or substantially producible by blowing into said chambers (4, 5, 6) simultaneously.

31. A method of refereeing including blowing into a whistle (1) as claimed in any one of claims 1 to 28 or utilising a sound as claimed in claim 29 or claim 30 or a sound substantially similar thereto or a sound characteristic similar to prototype No.9 shown in FIG. 10a of the accompanying drawings.

32. Use of a sound as claimed in claim 29 or claim 30 in a sports event or use of a whistle (1) or apparatus capable of producing such a sound.

33. A whistle (1) or sound generator adapted to produce an effective sound of about 70 to 84 dBA at a flow rate of about 12 to 13 liters/second with a sound of 11 dBA or above at a flow rate of about 120 liters/second or above.

34. A whistle (1) substantially as herein described with reference to FIGS. 11a and 11b, or FIGS. 12a and 12b, or FIGS. 13a, 13b, 13c of the accompanying drawings.
